(19) United States
(12) Patent Application Publication
(10) Pub. No.: US 2024/0333462 A1
(43) Pub. Date: Oct. 3, 2024

(54) USER EQUIPMENT CAPABILITY SIGNALING FOR SCHEDULING TO AVOID SYMBOL BLANKING

(71) Applicant: Skyworks Solutions, Inc., Irvine, CA (US)

(72) Inventors: Laurent Noel, Laval (CA); Dominique Michel Yves Brunel, Antibes (FR)

(21) Appl. No.: 18/622,616

(22) Filed: Mar. 29, 2024

Related U.S. Application Data
(60) Provisional application No. 63/455,732, filed on Mar. 30, 2023.

(51) Int. Cl. H04L 5/00

(52) U.S. Cl. CPC H04L 5/0053; H04L 5/0007

(57) ABSTRACT

A mobile device having a capability of skipping symbol blanking, the mobile device comprising a transceiver, a radio frequency front end system coupled to the transceiver and a baseband system configured to generate a sequence of symbols for transmission to a base station by way of the radio frequency front end system coupled to the transceiver, and to generate a sequence of symbols including capability information, the capability information indicating that the mobile device has the capability of skipping symbol blanking.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

Embodiments of the invention relate to electronic systems, and in particular, to radio frequency (RF) electronics.

### Description of the Related Technology

RF communication systems can be used for transmitting and/or receiving signals of a wide range of frequencies. For example, an RF communication system can be used to wirelessly communicate RF signals in a frequency range of about 30 kHz to 300 GHz, such as in the range of about 450 MHz to about 7.125 GHz for certain communications standards, e.g., Fifth Generation (5G) cellular communications using Frequency Range 1 (FR1) and/or Frequency Range 2 (FR2).

Examples of RF communication systems include, but are not limited to, mobile phones, tablets, base stations, network access points, customer-premises equipment (CPE), laptops, and wearable electronics.

### SUMMARY OF CERTAIN INVENTIVE CONCEPTS

Symbol blanking degrades 5G throughput performance and latency. This problem is considered as critical for Ultra-Reliable Low Latency Communication (URLLC) use cases for which low latency may require 2 orthogonal frequency-division multiplexing (OFDM) symbol short subslot transmissions. Blanking one symbol out of two OFDM symbols results in severe latency and throughput penalty. Lowest latency is achieved at highest Sub-Carrier Spacing (SCS). Symbol blanking also prevents radio access network (RAN) from configuring SRS Antenna Switching (SRS-AS) in the special slot used in TDD commercial deployments. For example, in special slot configuration 10 DL symbols (downlink): 2 X (flexible) symbols: 2 UL (uplink) symbols (aka 10:2:2), it is not possible to perform 1T4R SRS-AS due to symbol blanking/guard symbols required after the first UL symbol, i.e. the 2^{nd} symbol is lost and AS can not be performed. For Frequency Range (FR) 1 (450 MHz to 7.125 GHz), highest SCS is 60 kHz. For FR 2-1 (24.3 to 52.6 GHz) the highest SCS is 120 kHz. For FR 2-2 (52.6 to 71.0 GHz) the highest SCS is 960 kHz. Blanking is specified for SCS 60 kHz in FR1 for consecutive SRS transmissions when power change is required and for consecutive short subslot transmissions. Symbol blanking is also specified for FR1 at SCS 15 kHz and SCS 30 kHz for SRS Antenna Switching (SRS-AS). For FR2-1, symbol blanking is specified for SCS 120 kHz for consecutive SRS transmissions and consecutive short sub-slot transmissions. Symbol blanking is not yet specified for FR2-2.

In FR1, TS 38.101-1 has defined a common RF transient period time of 10 microseconds (10 μs) to support all use cases for all Sub-Carrier Spacing (SCS). At 60 kHz SCS, the symbol duration is 18.36 μs (long symbol) and 17.84 μs for first and subsequent symbols in a slot. Symbol blanking is agreed since 10 μs transients lead to losing a large portion of the OFDM symbol, and therefore severely impact the 5G base-station (gNb) demodulation performance.

In FR2, TS 38.101-2 has defined a common RF transient period time of 5 μs to support all use cases for all SCS. At 120 kHz SCS, the symbol duration is 9.44 μs (long symbol) and 8.92 μs for first and subsequent symbols in a slot. Symbol blanking is agreed since 5 μs transients lead to losing a large portion of the OFDM symbol, and therefore severely impact the gNb demodulation performance.

R4-1901398 provides link level simulations showing how the base-station demodulation Signal to Noise Ratio (SNR) degrades vs. the duration of the UE RF transient period.

R4-1810089 UE reported that, with current transient period specifications for highest SCS, if a transient period would be needed on both side of a symbol, both transient periods would be put in that symbol and the symbol would be blanked (a symbol's length is 17.86 μs for FR1 while the sum of the two transients would be 20 μs). That symbol would then be completely lost. The consequence would be that features like frequency hopping every symbol might not be possible to support for highest SCS.

To address these problems, R4-1810089 proposes that a UE should report to the BS its supported transient time parameters for each supported SCS for FR1 based on the idea that if the gNb knows the UEs transient period performance capability expressed in microseconds, then the scheduler can enhance throughput and latency performance for that UE. The UE capability signaling message is specified for FR1 as an optional feature, and TS 38.101-1 Release 16 (Rel-16) and subsequent releases provides a set of Error Vector Magnitude (EVM) equations and a set of definitions of the EVM measurement Fast Fourier Transform (FFT) start positions to verify the declared transient period capability in FR1.

For each supported frequency band of operation within FR1, each UE declares its capability for transient period, and the gNb computes the total transient period for a given symbol. A scheduler takes this information into account to decide whether scheduling is feasible or not.

TS 38.101-1 Rel-16 details the signaling capability further. According to TS 38.101-1, the options for transient period capability to choose from are: 2 μs, 4 μs or 7 μs. If the UE does not declare any transient period, it is assumed that the default 10 μs applies for FR1. The transient period capability is specified only for FR1. R4-2300034 further proposes that testing should use a transient EVM test procedure similar to LTE, using CP-OFDM waveforms only, averaged over 104 subframes, using a periodic alternating RB allocation change test pattern that triggers an ON-to-ON power transient that alternates either power step-up or power step-down transients etc.

Despite the agreed specifications of the previous solutions, the 3GPP working group RAN4 has decided to maintain symbol blanking for FR1 in the ON/OFF time-masks of TS 38.101-1 sub-clause 6.3.3. Therefore, even if the UE declares a shorter transient period, blanked symbols are still required for SRS, SRS-AS and short subslot transmissions. The previous solution does not resolve issues related to symbol blanking issues. Contrary to the solutions presented in the above-mentioned proposals, the present application focuses on how symbol blanking may be avoided and such capability of skipping symbol blanking may by signaled. According to the solution of the present application, there are RF font-end architectures and power amplifier control techniques that ensures a UE can declare a shorter transient period capability in a given band of operation. Such intrinsic capability is the precondition to signal the basestation that symbol blanking is not required. Upon reception of this new capability, the basestation scheduler can therefore resolve all issues related to symbol blanking and may deliver superior performance. This capability resolves symbol blanking issues resulting from the following TS 38.101-1 time-masks: FIG. 6.3.3.6-4, FIG. 6.3.3.6-5, FIG. 6.3.3.9-3.

The systems, methods and devices of this disclosure each have several aspects, no single one of which is solely responsible for the desirable attributes disclosed herein.

For FR2, the present application proposes to introduce two signaling capabilities. First a signaling capability indicating the UE is able to support shorter transients per each band of operation. Secondly, a signaling capability that indicates that symbol blanking is not required for consecutive SRS transmissions with power change (TS 38.101-2 FIG. 6.3.3.6-4) and for consecutive short sub-slot transmissions (TS 38.101-2 FIG. 6.3.3.9-3).

### BRIEF DESCRIPTION OF THE DRAWINGS

FIG. 1 is a schematic diagram of one example of a communication network.

FIG. 2A is a diagram of an example dual connectivity network topology

FIG. 2B is a schematic diagram of one example of a communication link using carrier aggregation.

FIG. 2C illustrates various examples of uplink carrier aggregation for the communication link of FIG. 2B.

FIG. 2D illustrates various examples of downlink carrier aggregation for the communication link of FIG. 2B.

FIG. 3A is a schematic diagram of one example of a downlink channel using multi-input and multi-output (MIMO) communications.

FIG. 3B is schematic diagram of one example of an uplink channel using MIMO communications.

FIG. 3C is schematic diagram of another example of an uplink channel using MIMO communications.

FIG. 4 is a schematic diagram illustrating two examples of multiple access schemes for a communication network.

FIG. 5A is a schematic diagram of one example of a communication system that operates with beamforming.

FIG. 5B is a schematic diagram of one example of beamforming to provide a transmit beam.

FIG. 5C is a schematic diagram of one example of beamforming to provide a receive beam.

FIG. 6A is a diagram depicting the OFF-to-ON time masks according to 3GPP TS 38.101-1 V18.0.0 (FR1) and 3GPP TS 38.101-1 V18.0.0 (FR2) for the case of consecutive SRS transmissions when power change is required at SCS 60 kHz for FR1 and at SCS 120 kHz for FR2 in which symbol blanking is involved.

FIG. 6B is a diagram depicting the ON-to-ON PUCCH/PUSCH/SRS time-mask when the SRS sounding is performed on different antenna ports and the OFF-to-ON time-mask for consecutive SRS transmission with antenna-switching at SCS 60 kHz where the transient period is 10 s. For PUCCH/PUSCH/SRS, symbol blanking may occur due to the 15 μs transient period being absorbed by the symbol preceding and the symbol following the SRS transmission. For the case consecutive SRS transmissions, symbol blanking occurs due to the 10 μs transient period being placed in a symbol rather than at the symbol boundaries.

FIG. 6C is a table depicting one example of various communication parameters versus SCS.

FIG. 6D illustrates the consecutive short subslot (1 symbol gap) time mask for the case when the 10 μs transient period is placed in the blanked symbols when 60 kHz SCS is used in FR1, and the case when the 5 μs transient period is placed in the blanked symbol when 120 kHz SCS is used in FR2, as specified in Release 18 of 3GPP TS 38.101-1 FIG. 6.3.3.6-9 for FR1 and in TS 38.101-2 FIG. 6.3.3.6-9 for FR2.

FIG. 7A is a schematic diagram of one example of a communication system operating with SRS for one transmit four receive (1T4R).

FIG. 7B is one example of a timing diagram for the communication system of FIG. 7A.

FIG. 8A is a schematic diagram of one example of a communication system operating with SRS for two transmit four receive (2T4R).

FIG. 8B is one example of a timing diagram for the communication system of FIG. 8A.

FIG. 9A is a schematic diagram of one embodiment of a communication system operating with SRS for 2T4R.

FIG. 9B is one example of a timing diagram for the communication system of FIG. 9A.

FIG. 10A is a diagram of one example of an impact of transients on an uplink physical layer.

FIG. 10B is a diagram of another example of an impact of transients on an uplink physical layer.

FIG. 10C is a table of one example of an impact of transients on an uplink physical layer.

FIG. 11A is a schematic diagram of another embodiment of a communication system operating with SRS for 2T4R.

FIG. 11B is one example of a timing diagram for the communication system of FIG. 11A.

FIG. 12A is a schematic diagram of another embodiment of a communication system operating with SRS for 2T4R.

FIG. 12B is one example of a timing diagram for the communication system of FIG. 12A.

FIG. 13 is a schematic of an example illustrating how the measurements of EVM with transients may be performed in e.g. FR1 to verify the UE reported shorter transient period capability. As can be seen in FIG. 13, no EVM measurement is performed during the transient period.

FIG. 14 is a schematic diagram of one embodiment of a mobile device.

FIG. 15 is a schematic diagram of one embodiment of an RF communication system.

FIG. 16 is a schematic diagram of another embodiment of an RF communication system.

### DETAILED DESCRIPTION OF EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IoT), Vehicle-to-Everything (V2X), and High Power User Equipment (HPUE).

3GPP introduced Phase 1 of fifth generation (5G) technology in Release 15, and developed 5G technology further in Release 16. Subsequent 3GPP releases will further evolve and expand 5G technology. 5G technology is also referred to herein as 5G New Radio (NR).

Preliminary specifications for 5G NR support a variety of features, such as communications over millimeter wave spectrum, beam forming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

### Communication Network

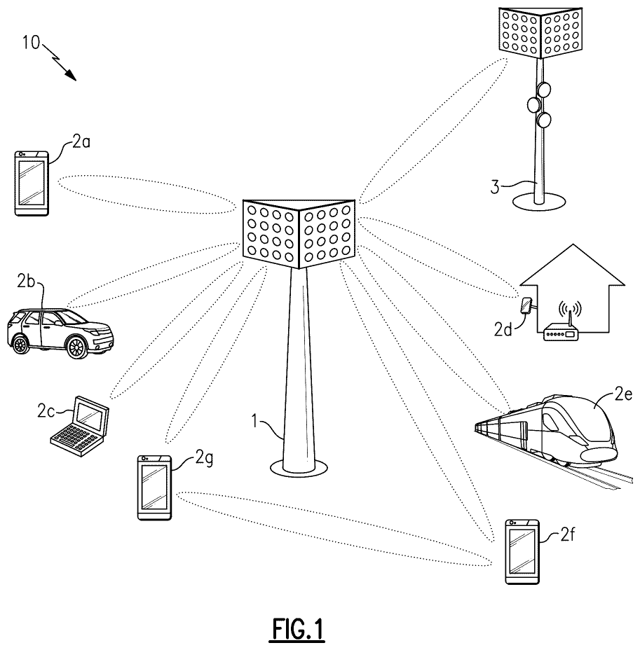

FIG. 1 is a schematic diagram of one example of a communication network 10. The communication network 10 includes a macro cell base station 1, a small cell base station 3, and various examples of user equipment (UE), including a first mobile device 2a, a wireless-connected car 2b, a laptop 2c, a stationary wireless device 2d, a wireless-connected train 2e, a second mobile device 2f, and a third mobile device 2g.

Although specific examples of base stations and user equipment are illustrated in FIG. 1, a communication network can include base stations and user equipment of a wide variety of types and/or numbers.

For instance, in the example shown, the communication network 10 includes the macro cell base station 1 and the small cell base station 3. The small cell base station 3 can operate with relatively lower power, shorter range, and/or with fewer concurrent users relative to the macro cell base station 1. The small cell base station 3 can also be referred to as a femtocell, a picocell, or a microcell. Although the communication network 10 is illustrated as including two base stations, the communication network 10 can be implemented to include more or fewer base stations and/or base stations of other types.

Although various examples of user equipment are shown, the teachings herein are applicable to a wide variety of user equipment, including, but not limited to, mobile phones, tablets, laptops, IoT devices, wearable electronics, customer premises equipment (CPE), wireless-connected vehicles, wireless relays, and/or a wide variety of other communication devices. Furthermore, user equipment includes not only currently available communication devices that operate in a cellular network, but also subsequently developed communication devices that will be readily implementable with the inventive systems, processes, methods, and devices as described and claimed herein.

The illustrated communication network 10 of FIG. 1 supports communications using a variety of cellular technologies, including, for example, 4G LTE and 5G NR. In certain implementations, the communication network 10 is further adapted to provide a wireless local area network (WLAN), such as WiFi. Although various examples of communication technologies have been provided, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communicate with a base station using one or more of 4G LTE, 5G NR, and WiFi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed WiFi frequencies).

As shown in FIG. 1, the communication links include not only communication links between UE and base stations, but also UE to UE communications and base station to base station communications. For example, the communication network 10 can be implemented to support self-fronthaul and/or self-backhaul.

The communication links can operate over a wide variety of frequencies. In certain implementations, communications are supported using 5G NR technology over one or more frequency bands that are less than 6 Gigahertz (GHz) and/or over one or more frequency bands that are greater than 6 GHz. For example, the communication links can serve Frequency Range 1 (FR1), Frequency Range 2 (FR2), or a combination thereof. In one embodiment, one or more of the mobile devices support a HPUE power class specification.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz, or more particularly, 24 GHz to 30 GHz.

Different users of the communication network 10 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to, eMBB, uRLLC, and/or mMTC.

### Dual Connectivity

With the introduction of the 5G NR air interface standards, 3GPP has allowed for the simultaneous operation of 5G and 4G standards in order to facilitate the transition. This mode can be referred to as Non-Stand-Alone (NSA) 5G operation or E-UTRAN New Radio-Dual Connectivity (EN-DC) and involves both 4G and 5G carriers being simultaneously transmitted from a user equipment (UE).

In certain EN-DC applications, dual connectivity NSA involves overlaying 5G systems onto an existing 4G core network. For dual connectivity in such applications, the control and synchronization between the base station and the UE can be performed by the 4G network while the 5G network is a complementary radio access network tethered to the 4G anchor. The 4G anchor can connect to the existing 4G network with the overlay of 5G data/control.

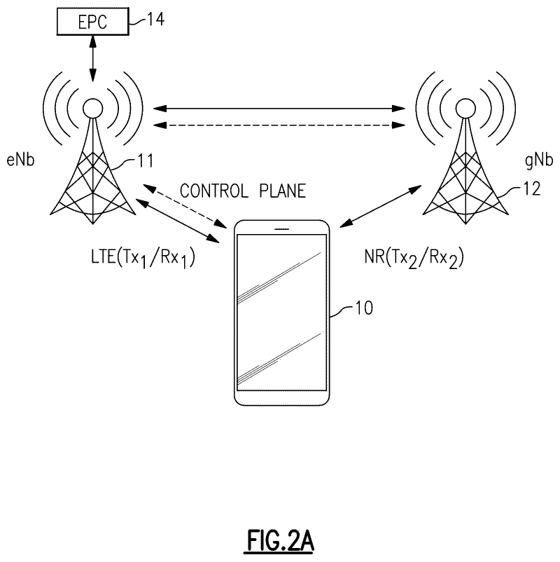

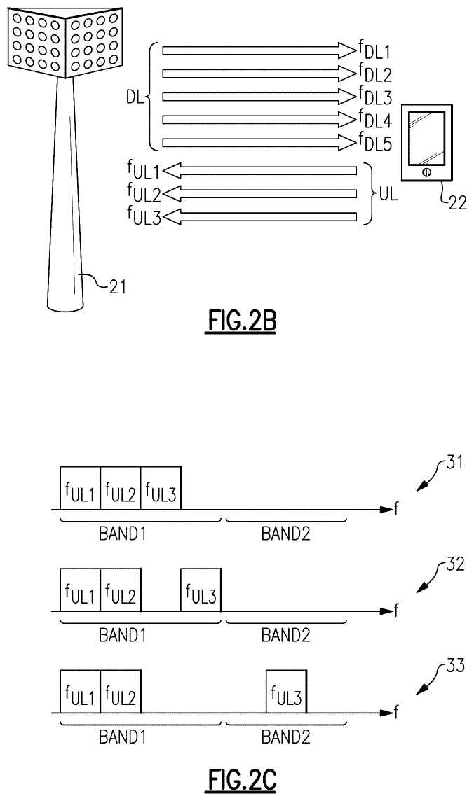

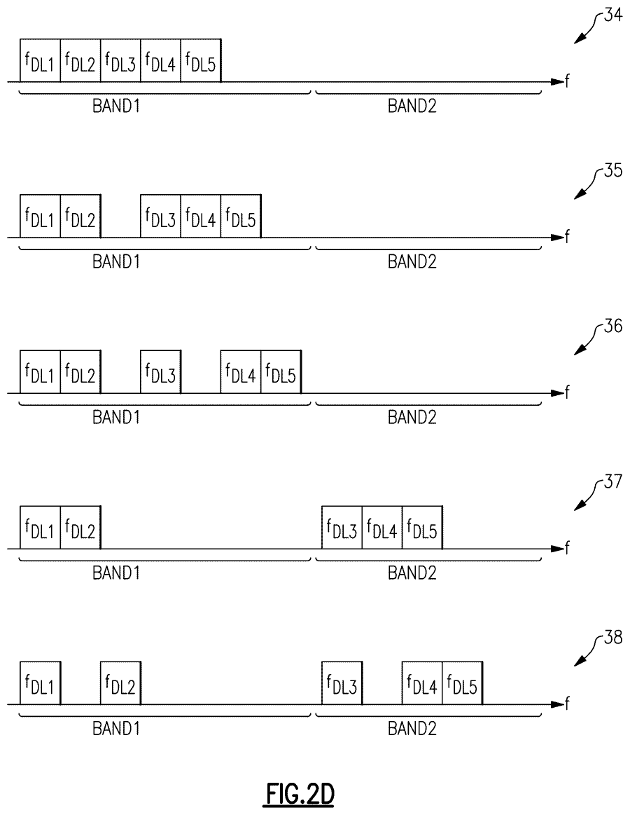

FIG. 2A is a diagram of an example dual connectivity network topology. This architecture can leverage LTE legacy coverage to ensure continuity of service delivery and the progressive rollout of 5G cells. A UE 10 can simultaneously transmit dual uplink LTE and NR carrier. The UE 10 can transmit an uplink LTE carrier Tx1 to the eNB 11 while transmitting an uplink NR carrier Tx2 to the gNB 12 to implement dual connectivity. Any suitable combination of uplink carriers Tx1, Tx2 and/or downlink carriers Rx1, Rx2 can be concurrently transmitted via wireless links in the example network topology of FIG. 2A. The eNB 11 can provide a connection with a core network, such as an Evolved Packet Core (EPC) 14. The gNB 12 can communicate with the core network via the eNB 11. Control plane data can be wireless communicated between the UE 10 and eNB 11. The eNB 11 can also communicate control plane data with the gNB 12. Control plane data can propagate along the paths of the dashed lines in FIG. 2A. The solid lines in FIG. 2A are for data plane paths.

In the example dual connectivity topology of FIG. 2A, any suitable combinations of standardized bands and radio access technologies (e.g., FDD, TDD, SUL, SDL) can be wirelessly transmitted and received. This can present technical challenges related to having multiple separate radios and bands functioning in the UE 10. With a TDD LTE anchor point, network operation may be synchronous, in which case the operating modes can be constrained to Tx1/Tx2 and Rx1/Rx2, or asynchronous which can involve Tx1/Tx2, Tx1/Rx2, Rx1/Tx2, Rx1/Rx2. When the LTE anchor is a frequency division duplex (FDD) carrier, the TDD/FDD inter-band operation can involve simultaneous Tx1/Rx1/Tx2 and Tx1/Rx1/Rx2.

As discussed above, EN-DC can involve both 4G and 5G carriers being simultaneously transmitted from a UE. This disclosure provides systems and methods of supporting EN-DC/NSA operation for concurrent UL transmission of both 4G (LTE anchor) and 5G signals, most often defined for inter-band dual connectivity and a kind of UL carrier aggregation

Architectures to support this require additional RF paths that support concurrent transmission. RF paths that are close enough in frequency (within what is termed a “band group” i.e. LB, MB, HB, UHB, etc.) are supported on a single trace to an antennaplexer (that further merges signals on bands with larger frequency offsets). Such bands on shared traces often need to be either ganged (i.e. trimmed or equilibrated to match each other) or switch-combined through a switch to be able to combine the signals onto that common trace. When this is the case, concurrent UL signals within that band group are problematic because full power UL signals will be on common trace and create large intermodulation products that then often fall into the active Rx victim channels and cause large Rx desensitization. In order to support concurrency on the maximum number of antennas and avoid or eliminate the IMD degradations, duplicated Tx RF paths are designed into the architecture with sufficient carrier aggregation support across all band combinations. This advantageously allows for being able to transmit on separate antennas with sufficient RF isolation to address the IMD and Rx impairments.

EN-DC is one application/architecture where the concept of the present invention works well. However, the concept is more generally applicable, not just for EN-DC modules.

### Carrier Aggregation

FIG. 2B is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2B, the communications link includes a downlink channel used for RF communications from the base station 21 to the mobile device 22, and an uplink channel used for RF communications from the mobile device 22 to the base station 21.

Although FIG. 2B illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous, and can include carriers separated in frequency within a common band or in different bands.

In the example shown in FIG. 2B, the uplink channel includes three aggregated component carriers fUL1, fUL2, and fUL3. Additionally, the downlink channel includes five aggregated component carriers fDL1, fDL2, fDL3, fDL4, and fDL5. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2C illustrates various examples of carrier aggregation for the communication link of FIG. 2B. FIG. 2C includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier fcc1, a second component carrier fcc2, and a third component carrier fcc3. Although FIG. 2C is illustrated in the context of aggregating three component carriers, carrier aggregation can be used to aggregate more or fewer carriers.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers fcc1, fcc2, and fcc3 that are contiguous and located within a first frequency band BAND1.

With continuing reference to FIG. 2C, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers fcc1, fcc2, and fcc3 that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers fcc1 and fcc2 of a first frequency band BAND1 with component carrier fcc3 of a second frequency band BAND2.

FIG. 2D illustrates various examples of downlink carrier aggregation for the communication link of FIG. 2B. The examples depict various carrier aggregation scenarios 34-38 for different spectrum allocations of a first component carrier fDL1, a second component carrier fDL2, a third component carrier fDL3, a fourth component carrier fDL4, and a fifth component carrier fDL5. Although FIG. 2D is illustrated in the context of aggregating five component carriers, carrier aggregation can be used to aggregate more or fewer carriers. Moreover, although illustrated in the context of downlink, the aggregation scenarios are also applicable to uplink.

The first carrier aggregation scenario 34 depicts aggregation of component carriers that are contiguous and located within the same frequency band. Additionally, the second carrier aggregation scenario 35 and the third carrier aggregation scenario 36 illustrates two examples of aggregation that are non-contiguous, but located within the same frequency band. Furthermore, the fourth carrier aggregation scenario 37 and the fifth carrier aggregation scenario 38 illustrates two examples of aggregation in which component carriers that are non-adjacent in frequency and in multiple frequency bands are aggregated. As a number of aggregated component carriers increases, a complexity of possible carrier aggregation scenarios also increases.

With reference to FIGS. 2B to 2D, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and second cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as WiFi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid WiFi users and/or to coexist with WiFi users. Enhanced license assisted access (eLAA) refers to an evolution of LAA that aggregates licensed and unlicensed spectrum for both downlink and uplink.

Carrier aggregation is one application/architecture where the concept of the present invention works well. However, the concept is more generally applicable, not just for Carrier aggregation modules.

### Multi-Input and Multi-Output (MIMO) Communications

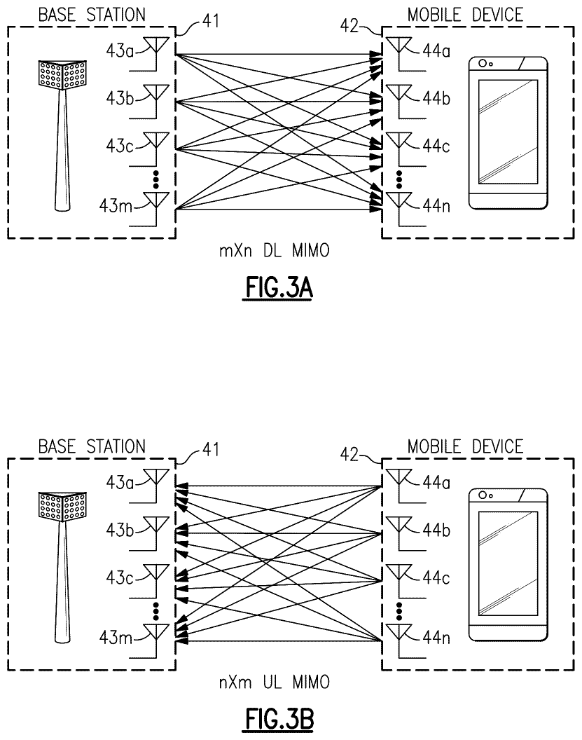

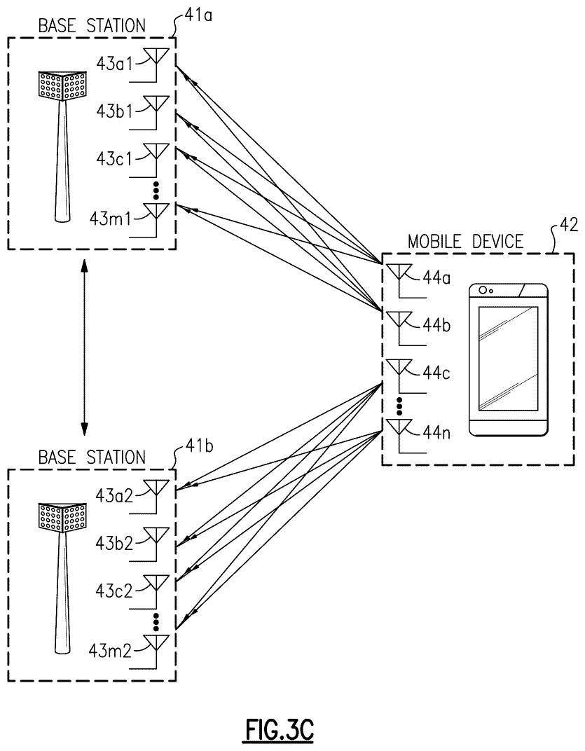

FIG. 3A is a schematic diagram of one example of a downlink channel using multi-input and multi-output (MIMO) communications. FIG. 3B is schematic diagram of one example of an uplink channel using MIMO communications.

MIMO communications use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two (2×2) DL MIMO refers to MIMO downlink communications using two base station antennas and two UE antennas. Additionally, four-by-four (4×4) DL MIMO refers to MIMO downlink communications using four base station antennas and four UE antennas.

In the example shown in FIG. 3A, downlink MIMO communications are provided by transmitting using M antennas 43a, 43b, 43c, . . . 43m of the base station 41 and receiving using N antennas 44a, 44b, 44c, . . . 44n of the mobile device 42. Accordingly, FIG. 3A illustrates an example of M×N DL MIMO.

Likewise, MIMO order for uplink communications can be described by a number of transmit antennas of UE, such as a mobile device, and a number of receive antennas of a base station. For example, 2×2 UL MIMO refers to MIMO uplink communications using two UE antennas and two base station antennas. Additionally, 4×4 UL MIMO refers to MIMO uplink communications using four UE antennas and four base station antennas.

In the example shown in FIG. 3B, uplink MIMO communications are provided by transmitting using N antennas 44a, 44b, 44c, . . . 44n of the mobile device 42 and receiving using M antennas 43a, 43b, 43c, . . . 43m of the base station 41. Accordingly, FIG. 3B illustrates an example of N×M UL MIMO.

By increasing the level or order of MIMO, bandwidth of an uplink channel and/or a downlink channel can be increased.

MIMO communications are applicable to dual connectivity and to communication links of a variety of types, such as FDD communication links and TDD communication links.

FIG. 3C is schematic diagram of another example of an uplink channel using MIMO communications. In the example shown in FIG. 3C, uplink MIMO communications are provided by transmitting using N antennas 44a, 44b, 44c, . . . 44n of the mobile device 42. Additionally, a first portion of the uplink transmissions are received using M antennas 43a1, 43b1, 43c1, . . . 43m1 of a first base station 41a, while a second portion of the uplink transmissions are received using M antennas 43a2, 43b2, 43c2, . . . 43m2 of a second base station 41b. Additionally, the first base station 41a and the second base station 41b communication with one another over wired, optical, and/or wireless links.

The MIMO scenario of FIG. 3C illustrates an example in which multiple base stations cooperate to facilitate MIMO communications.

MIMO is one application/architecture where the concept of the present invention works well. However, the concept is more generally applicable, not just for MIMO modules.

### Examples of Radio Frequency Electronics

A radio frequency (RF) communication device can include multiple antennas for supporting wireless communications. Additionally, the RF communication device can include a radio frequency front-end (RFFE) system for processing signals received from and transmitted by the antennas. The RFFE system can provide a number of functions, including, but not limited to, signal filtering, controlling component connectivity to the antennas, and/or signal amplification.

RFFE systems can be used to handle RF signals of a wide variety of types, including, but not limited to, wireless local area network (WLAN) signals, Bluetooth signals, and/or cellular signals.

Additionally, RFFE systems can be used to process signals of a wide range of frequencies. For example, certain RFFE systems can operate using one or more low bands (for example, RF signal bands having a frequency content of 1 GHz or less, also referred to herein as LB), one or more mid bands (for example, RF signal bands having a frequency content between 1 GHz and 2.3 GHz, also referred to herein as MB), one or more high bands (for example, RF signal bands having a frequency content between 2.3 GHz and 3 GHz, also referred to herein as HB), and one or more ultrahigh bands (for example, RF signal bands having a frequency content between 3 GHz and 6 GHz, also referred to herein as UHB).

RFFE systems can be used in a wide variety of RF communication devices, including, but not limited to, smartphones, base stations, laptops, handsets, wearable electronics, and/or tablets.

A RFFE system can be implemented to support a variety of features that enhance bandwidth and/or other performance characteristics of the RF communication device in which the RFFE system is incorporated.

In one example, a RFFE system is implemented to support carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels, for instance up to five carriers. Carrier aggregation includes contiguous aggregation, in which contiguous carriers within the same operating frequency band are aggregated. Carrier aggregation can also be non-contiguous, and can include carriers separated in frequency within a common band or in different bands.

In another example, a RFFE system is implemented to support multi-input and multi-output (MIMO) communications to increase throughput and enhance mobile broadband service. MIMO communications use multiple antennas for communicating multiple data streams over a single radio frequency channel. MIMO communications benefit from higher signal to noise ratio, improved coding, and/or reduced signal interference due to spatial multiplexing differences of the radio environment.

MIMO order refers to a number of separate data streams sent or received. For instance, a MIMO order for downlink communications can be described by a number of transmit antennas of a base station and a number of receive antennas for user equipment (UE), such as a mobile device.

RFFE systems that support carrier aggregation and multi-order MIMO can be used in RF communication devices that operate with wide bandwidth. For example, such RFFE systems can be used in applications servicing multimedia content streaming at high data rates.

Fifth Generation (5G) technology seeks to achieve high peak data rates above 10 Gbps. Certain 5G high-speed communications can be referred to herein as Enhanced Multi-user Broadband (eMBB).

To achieve eMBB data rates, RF spectrum available at millimeter wave frequencies (for instance, 30 GHz and higher) is attractive, but significant technical hurdles are present in managing the loss, signal conditioning, radiative phased array aspects of performance, beam tracking, test, and/or packaging in the handset associated with millimeter wave communications.

The RFFE systems herein can operate using not only LB, MB, and HB frequencies, but also ultrahigh band (UHB) frequencies in the range of about 3 GHz to about 6 GHz, and more particular between about 3.4 GHz and about 3.8 GHz. By communicating using UHB, enhanced peak data rates can be achieved without the technical hurdles associated with millimeter wave communications.

In certain implementations herein, UHB transmit and receive modules are employed for both transmission and reception of UHB signals via at least two primary antennas and at least two diversity antennas, thereby providing both 4×4 RX MIMO and 4×4 TX MIMO with respect to one or more UHB frequency bands, such as Band 42 (about 3.4 GHz to about 3.6 GHz), Band 43 (about 3.6 GHz to about 3.8 GHz), and/or Band 48 (about 3.55 GHz to about 3.7 GHz). Furthermore, in certain configurations, the RFFE systems herein employ carrier aggregation using one or more UHB carrier frequencies, thereby providing flexibility to widen bandwidth for uplink and/or downlink communications.

By enabling high-order MIMO and/or carrier aggregation features using UHB spectrum, enhanced data rates can be achieved. Additionally, rather than using dedicated 5G antennas and a separate transceiver, shared antennas and/or a shared transceiver (for example, a semiconductor die including a shared transceiver fabricated thereon) can be used for both 5G UHB communications and 4G/LTE communications associated with HB, MB, and/or LB. Thus, 4G/LTE communications systems can be extended to support sub-6 GHz 5G capabilities with a relatively small impact to system size and/or cost.

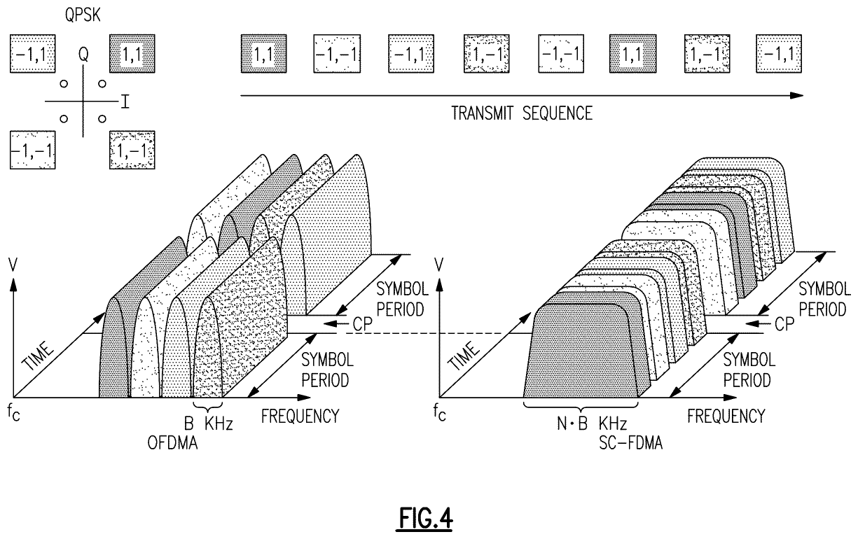

FIG. 4 is a schematic diagram illustrating two examples of multiple access schemes for a communication network. Examples of frequency versus voltage versus time for OFDMA and SC-FDMA are depicted in FIG. 4.

The examples are shown for an illustrated transmit sequence of different QPSK modulating data symbols, in this embodiment. As shown in FIG. 4, SC-FDMA includes data symbols occupying greater bandwidth (N*B KHz, where N=4 in this example) relative to OFDMA data symbols (B KHz). However, the SC-FDMA data symbols occupy the greater bandwidth for a fraction of time (1/N) relative to that of the OFDMA data symbols. FIG. 4 has also been annotated to show times of transmitting a cyclic prefix (CP).

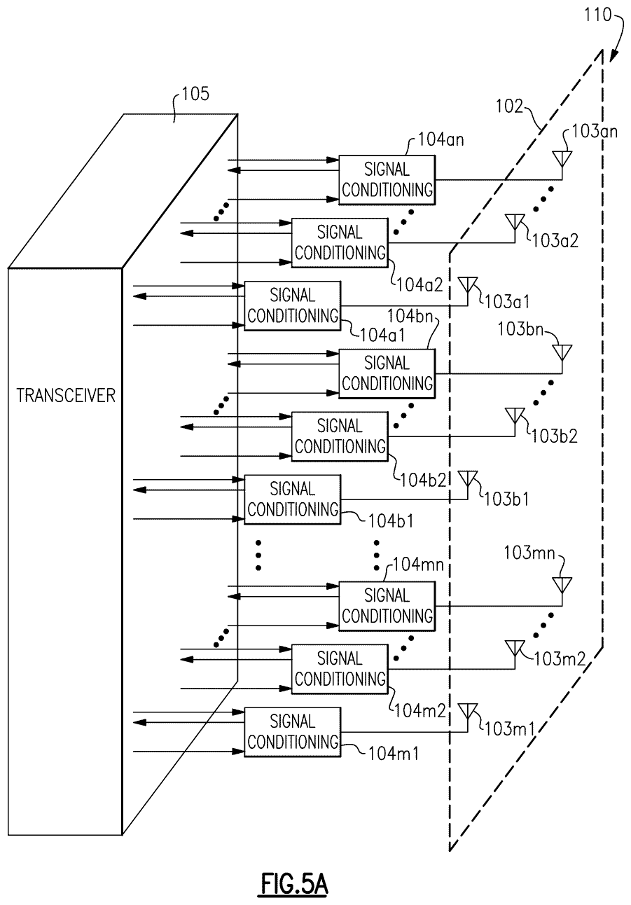

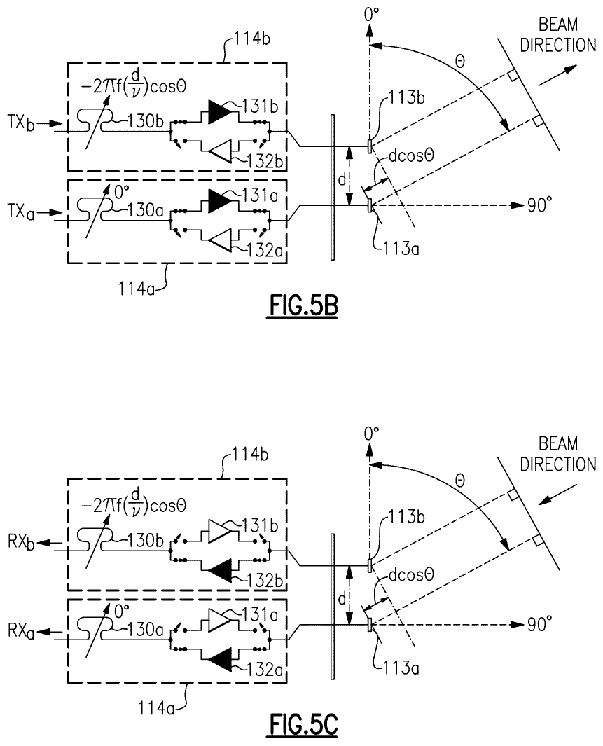

FIG. 5A is a schematic diagram of one example of a communication system 110 that operates with beamforming. The communication system 110 includes a transceiver 105, signal conditioning circuits 104a1, 104a2 . . . 104an, 104b1, 104b2 . . . 104bn, 104m1, 104m2 . . . 104mn, and an antenna array 102 that includes antenna elements 103a1, 103a2 . . . 103an, 103b1, 103b2 . . . 103bn, 103m1, 103m2 . . . 103mn.

Communications systems that communicate using millimeter wave carriers (for instance, 30 GHz to 300 GHz), centimeter wave carriers (for instance, 3 GHz to 30 GHz), and/or other frequency carriers can employ an antenna array to provide beam formation and directivity for transmission and/or reception of signals.

For example, in the illustrated embodiment, the communication system 110 includes an array 102 of m×n antenna elements, which are each controlled by a separate signal conditioning circuit, in this embodiment. As indicated by the ellipses, the communication system 110 can be implemented with any suitable number of antenna elements and signal conditioning circuits.

With respect to signal transmission, the signal conditioning circuits can provide transmit signals to the antenna array 102 such that signals radiated from the antenna elements combine using constructive and destructive interference to generate an aggregate transmit signal exhibiting beam-like qualities with more signal strength propagating in a given direction away from the antenna array 102.

In the context of signal reception, the signal conditioning circuits process the received signals (for instance, by separately controlling received signal phases) such that more signal energy is received when the signal is arriving at the antenna array 102 from a particular direction. Accordingly, the communication system 110 also provides directivity for reception of signals.

The relative concentration of signal energy into a transmit beam or a receive beam can be enhanced by increasing the size of the array. For example, with more signal energy focused into a transmit beam, the signal is able to propagate for a longer range while providing sufficient signal level for RF communications. For instance, a signal with a large proportion of signal energy focused into the transmit beam can exhibit high effective isotropic radiated power (EIRP).

In the illustrated embodiment, the transceiver 105 provides transmit signals to the signal conditioning circuits and processes signals received from the signal conditioning circuits. As shown in FIG. 5A, the transceiver 105 generates control signals for the signal conditioning circuits. The control signals can be used for a variety of functions, such as controlling the gain and phase of transmitted and/or received signals to control beamforming.

FIG. 5B is a schematic diagram of one example of beamforming to provide a transmit beam. FIG. 5B illustrates a portion of a communication system including a first signal conditioning circuit 114a, a second signal conditioning circuit 114b, a first antenna element 113a, and a second antenna element 113b.

Although illustrated as included two antenna elements and two signal conditioning circuits, a communication system can include additional antenna elements and/or signal conditioning circuits. For example, FIG. 5B illustrates one embodiment of a portion of the communication system 110 of FIG. 5A.

The first signal conditioning circuit 114a includes a first phase shifter 130a, a first power amplifier 131a, a first low noise amplifier (LNA) 132a, and switches for controlling selection of the power amplifier 131a or LNA 132a. Additionally, the second signal conditioning circuit 114b includes a second phase shifter 130b, a second power amplifier 13ib, a second LNA 132b, and switches for controlling selection of the power amplifier 131b or LNA 132b.

Although one embodiment of signal conditioning circuits is shown, other implementations of signal conditioning circuits are possible. For instance, in one example, a signal conditioning circuit includes one or more band filters, duplexers, and/or other components.

In the illustrated embodiment, the first antenna element 113a and the second antenna element 113b are separated by a distance d. Additionally, FIG. 5B has been annotated with an angle θ, which in this example has a value of about 90° when the transmit beam direction is substantially perpendicular to a plane of the antenna array and a value of about 0° when the transmit beam direction is substantially parallel to the plane of the antenna array.

By controlling the relative phase of the transmit signals provided to the antenna elements 113a, 113b, a desired transmit beam angle θ can be achieved. For example, when the first phase shifter 130a has a reference value of 0°, the second phase shifter 130b can be controlled to provide a phase shift of about −2πf(d/v)cos θ radians, where f is the fundamental frequency of the transmit signal, d is the distance between the antenna elements, v is the velocity of the radiated wave, and π is the mathematic constant pi.

In certain implementations, the distance d is implemented to be about ½λ, where λ is the wavelength of the fundamental component of the transmit signal. In such implementations, the second phase shifter 130b can be controlled to provide a phase shift of about −π cos θ radians to achieve a transmit beam angle θ.

Accordingly, the relative phase of the phase shifters 130a, 130b can be controlled to provide transmit beamforming. In certain implementations, a baseband processor and/or a transceiver (for example, the transceiver 105 of FIG. 5A) controls phase values of one or more phase shifters and gain values of one or more controllable amplifiers to control beamforming.

FIG. 5C is a schematic diagram of one example of beamforming to provide a receive beam. FIG. 5C is similar to FIG. 5B, except that FIG. 5C illustrates beamforming in the context of a receive beam rather than a transmit beam.

As shown in FIG. 5C, a relative phase difference between the first phase shifter 130a and the second phase shifter 130b can be selected to about equal to −2πf(d/v)cos θ radians to achieve a desired receive beam angle θ. In implementations in which the distance d corresponds to about ½λ, the phase difference can be selected to about equal to −π cos θ radians to achieve a receive beam angle θ.

Although various equations for phase values to provide beamforming have been provided, other phase selection values are possible, such as phase values selected based on implementation of an antenna array, implementation of signal conditioning circuits, and/or a radio environment.

### Sounding Reference Signal Switching

In cellular networks, such as 5G networks, sounding reference signal (SRS) features can be enabled to determine channel qualities of a communication link between UE (for example, a wireless device such as a mobile phone) and a base station. SRS symbols are transmitted on uplink and processed by the network to estimate the quality of the wireless channel at different frequencies. For instance, the SRS symbols transmitted by the UE can be used by the base station to estimate the quality of the uplink channel for large bandwidths outside the assigned frequency span to the UE.

Although SRS provides a number of benefits, SRS also places a burden on data transport capacity.

For example, for 3GPP 5G Release 15, ON to ON timing for consecutive SRS symbols is 15 microseconds (s) for Frequency Range 1 (FR1). For a subcarrier spacing (SCS) of 15 kilohertz (kHz), the cyclic prefix (CP) and 10 μs of the preceding data symbol is consumed. At 30 kHz and 60 kHz SCS 15 μs the ON to ON timing constraint corresponds to about half a symbol and a full symbol, respectively. Thus, a full symbol can be lost or blanked when 30 kHz or 60 kHz SCS is enabled.

Apparatus and methods for SRS switching are provided. In certain embodiments, transmit path resources of UE are used to reduce or eliminate the impairment of SRS upon transport capacity. Furthermore, the transmit path resources can be used for other purposes, and thus SRS switching time can be reduced by re-using transmit path resources that may be included for other purposes. The teachings herein can be used to achieve SRS switching of 0 μs, thereby eliminating the impact of switching timing constraints for SRS symbols on transport capacity.

In certain implementations, the UE includes a first transmit path associated with a first power amplifier, and a second transmit path associated with a second power amplifier. Additionally, when the second transmit path is not in use for other purposes, symbol transmissions are staggered using the first transmit path and the second transmit path, with at least the second transmit path used for transmitting SRS symbols. Thus, a power amplifier associated with an antenna not in operation for data transport can be used for SRS signaling. Implementing SRS in this manner can provide a number of advantages, including, but not limited to, 0 μs SRS switching.

In certain implementations, the first transmit path and the second transmit path correspond to transmit paths used for transmitting MIMO signals. For example, in the context of a UE capable of UL MIMO and not in MIMO mode, the first power amplifier (PA1) is used for data transport activities while the second power amplifier (PA2) is engaged for SRS.

Thus, a UE capable of UL MIMO and not in MIMO mode alternates transmit path resources to provide SRS. By using the other power amplifier, SRS can be achieved without overhead on data transport.

Such low overhead provides a number of advantages. For example, 0 s SRS switching can be realized to achieve lower latency and enhanced performance relative to an implementation in which time is set aside to permit SRS on a particular antenna by shortening or blanking a symbol.

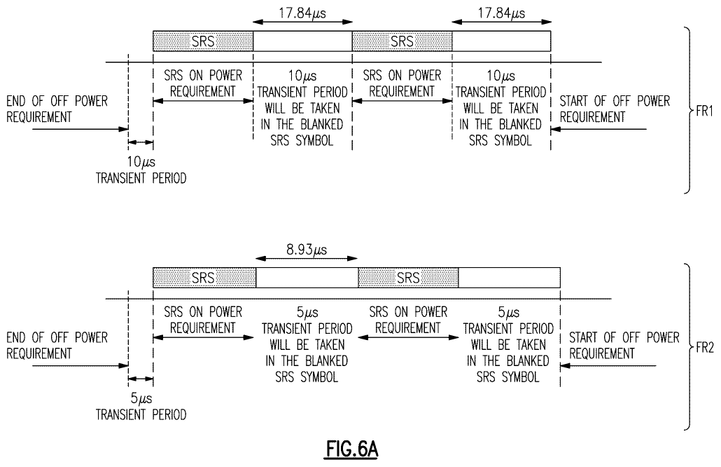

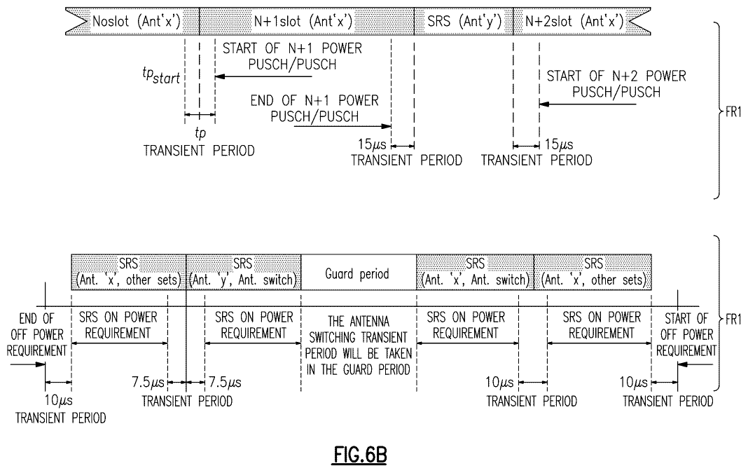

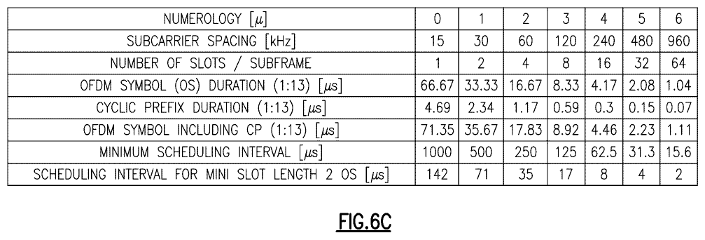

FIG. 6A is a diagram depicting two time masks according to 3GPP TS 38.101-1 V18.0.0 (FR1) and 3GPP TS 38.101-1 V18.0.0 (FR2) for the case when power change is required and symbol blanking is involved.

The upper part of FIG. 6A illustrates a consecutive SRS time mask for the case when power change is required and when 60 kHz SCS is used in FR1, when the transient period is 10 p s.

The lower part of FIG. 6A illustrates a consecutive SRS time mask for the case when power change is required and when 120 kHz SCS is used in FR2, when the transient period is 5 p s.

FIG. 6B is a diagram depicting two time masks according to 3GPP TS 38.101-1 V18.0.0 (FR1) in which symbol blanking is involved. Certain cellular networks are implemented with an uplink physical layer that includes multiple physical channels. In one example, a cellular network includes a Physical Uplink Shared Channel (PUSCH) and a Physical Uplink Control Channel (PUCCH). Additionally, the PUSCH is used for transmitting user traffic data, while PUCCH carriers Uplink Control Information (UCI) indicating channel quality and other parameters.

The upper part of FIG. 6B illustrates the PUCCH/PUSCH/SRS time mask when there is a transmission before or after or both before and after SRS, when sounded on a different antenna (Ant ‘x’ and Ant ‘y’ are different antenna ports)

The PUCCH/PUSCH/SRS time mask defines the observation period between sounding reference symbol (SRS) and an adjacent PUSCH/PUCCH symbol and subsequent UL transmissions. The time masks apply for all types of frame structures and their allowed PUCCH/PUSCH/SRS transmissions unless otherwise stated. Symbol blanking may occur in the symbol that precedes and in the symbol that follows the SRS antenna switching transmission due to the 15 μs transient period placed entirely in the symbol before and in the symbol after the SRS transmission.

The lower part of FIG. 6B illustrates the time mask for 15 kHz and 30 kHz SCS for the case when consecutive SRS switching usage is between antenna switching and other sets where “other sets” belongs to a “usage set” other than the set for antenna switching. The usage sets for SRS switching are defined in clause 6.2.1 of TS 38.214.

TABLE 1 below shows one example of subcarrier spacing Δf and symbol blanking Y versus numerology μ.

TABLE 1

| numerology μ | SCS = Δf = 2^{μ} · 15 [kHz] | Y [symbol] |
|---|---|---|
| 0 | 15 | 1 |
| 1 | 30 | 1 |
| 2 | 60 | 1 |
| 3 | 120 | 2 |

In this example, one symbol blanking is permitted for SCS of 30 kHz and SCS of 60 kHz. Additionally, two symbol blanking is permitted for SCS of 120 kHz.

FIG. 6C is a table depicting one example of various communication parameters versus SCS.

In the example shown in FIG. 6C, CP scales linearly with SCS.

FIG. 6D illustrates the consecutive short subslot (1 symbol gap) time mask for the case when the ON-to-ON transient period is no longer symmetrically shared across adjacent symbols and when 60 kHz SCS is used in FR1, where the transient period is 10 μs, as specified in Release 18 of 3GPP TS 38.101-1, and when 120 kHz SCS is used in FR2, where the transient period is 5 μs, as specified in Release 18 of 3GPP TS 38.101-2. In both cases, the ON-to-ON transient period is taken into the blanked symbol.

As shown in FIG. 6D, 1 symbol is blanked every other symbol for the case of consecutive symbol transmissions in short subslots. In FR1 (FR2), a short subslot transmission is a (type B) transmission with 1 or 2 symbols. Hence, the consecutive short subslot (1 symbol gap) time mask impacts both throughput and latency.

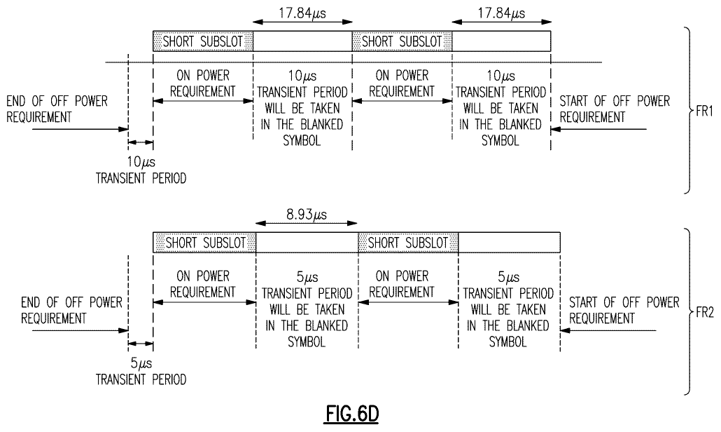

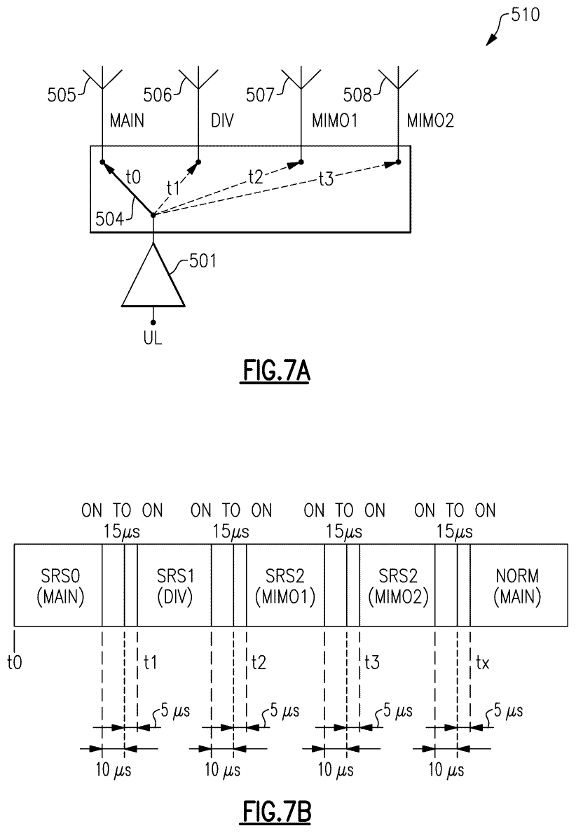

FIG. 7A is a schematic diagram of one example of a communication system 510 operating with SRS for one transmit four receive (1T4R). FIG. 7B is one example of a timing diagram for the communication system 510 of FIG. 7A.

With reference to FIGS. 7A and 7B, the communication system 510 includes a power amplifier 501 that is connected to a main antenna 505, a diversity antenna 506, a first MIMO antenna 507, and a second MIMO antenna 508 by a multi-throw switch 504.

When sounding all four antennas 503-506 at 15 kHz SCS, 4 symbols are used with whole CP and 10 μs of the preceding symbol affected. For 30 kHz and 60 kHz SCS, 7 symbols are used, 3 of which are blanks.

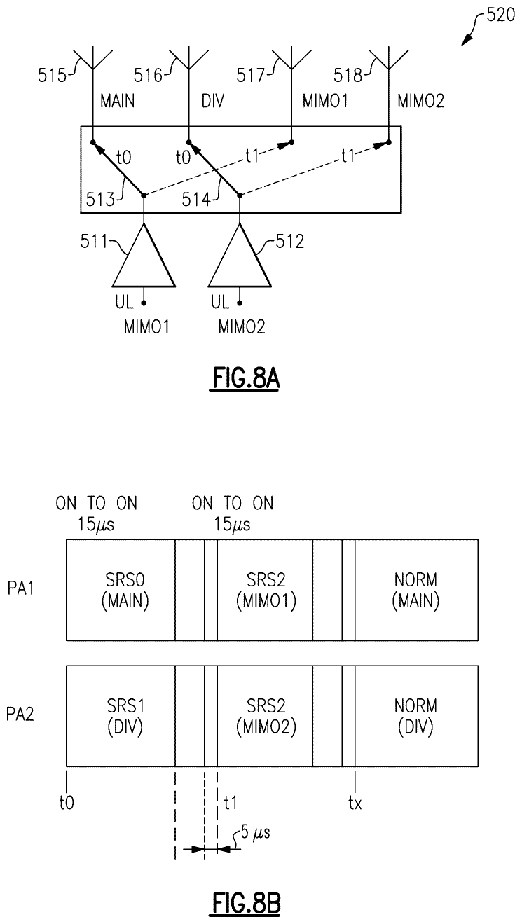

FIG. 8A is a schematic diagram of one example of a communication system 520 operating with SRS for two transmit four receive (2T4R). FIG. 8B is one example of a timing diagram for the communication system 520 of FIG. 8A.

With reference to FIGS. 8A and 8B, the communication system 520 includes a first power amplifier 511 that is connected to a main antenna 515 and a first MIMO antenna 517 by a first multi-throw switch 513. Additionally, the communication system 520 further includes a second power amplifier 512 that is connected to a diversity antenna 516 and a second MIMO antenna 518 by a second multi-throw switch 514.

When sounding all four antennas 515-518 at 15 kHz SCS, 2 symbols are used with whole CP and 10 μs of preceding symbol affected. For 30 kHz and 60 kHz SCS, 4 symbols are used, 2 of which are blanks.

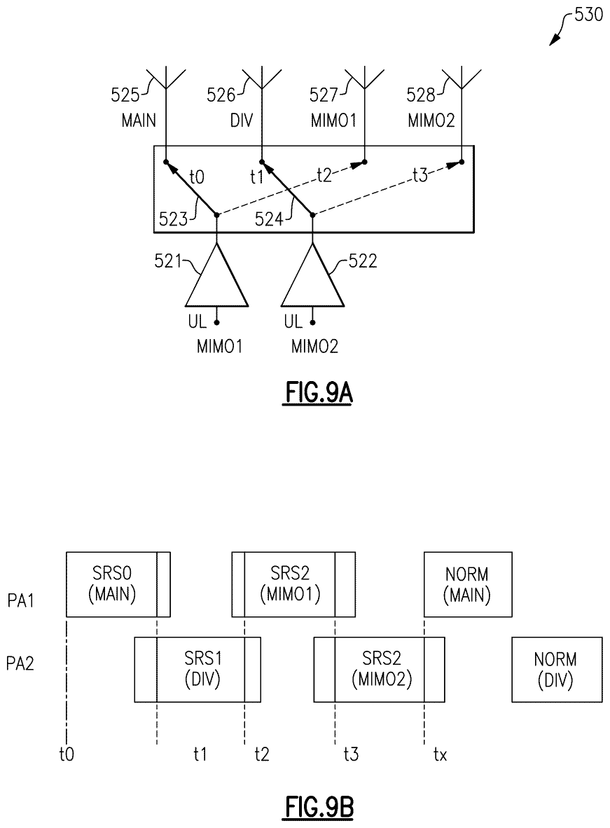

FIG. 9A is a schematic diagram of one embodiment of a communication system 530 operating with SRS for 2T4R. FIG. 9B is one example of a timing diagram for the communication system 530 of FIG. 9A.

With reference to FIGS. 9A and 9B, the communication system 530 includes a first power amplifier 521 that is connected to a main antenna 525 and a first MIMO antenna 527 by a first multi-throw switch 523. Additionally, the communication system 530 further includes a second power amplifier 522 that is connected to a diversity antenna 526 and a second MIMO antenna 528 by a second multi-throw switch 524.

When sounding all four antennas 525-528 at 15 kHz SCS, 4 symbols are used with SRS switching of about 0 μs. For 30 kHz and 60 kHz SCS, 4 symbols are used, with no blanks and SRS switching of about 0 s. Moreover, the ON/OFF switching is performed with less than 10 μs when uplink MIMO is supported.

According to Release 17 of 3GPP TS 38.214, in a UE sounding procedure for downlink (DL) channel state information (CSI) acquisition, when the UE is configured with the higher layer parameter usage in SRS-ResourceSet set as ‘antennaSwitching’, the UE may be configured with only one of the following configurations depending on the indicated UE capability supportedSRS-TxPortSw (‘t1r2’ for 1T2R, ‘t1r1-t1r2’ for 1T=1R/1T2R, ‘t2r4’ for 2T4R, ‘t1r4’ for 1T4R, ‘t1r6’ for 1T6R, ‘1t8r’ for 1T8R, ‘2t6r’ for 2T6R, ‘2t8r’ for 2T8R, ‘4t8r’ for 4T8R, ‘t1r1-t1r2-t1r4’ for 1T=1R/1T2R/1T4R, ‘t1r4-t2r4’ for 1T4R/2T4R, ‘t1r1-t1r2-t2r2-t2r4’ for 1T=1R/1T2R/2T=2R/2T4R, ‘t1r1-t1r2-t2r2-t1r4-t2r4’ for 1T=1R/1T2R/2T=2R/1T4R/2T4R, ‘t1r1’ for 1T=1R, ‘t2r2’ for 2T=2R, ‘t1r1-t2r2’ for 1T=1R/2T=2R, ‘t4r4’ for 4T=4R, or ‘t1r1-t2r2-t4r4’ for 1T=1R/2T=2R/4T=4).

Moreover, according to Release 17 of 3GPP TS 38.214, the UE is configured with a guard period of Y symbols, cf. TABLE 1 above, in which the UE does not transmit any other signal, in the case the SRS resources of a set are transmitted in the same slot. The guard period is in-between the SRS resources of the set.

In addition, according to Release 17 of 3GPP TS 38.214, the UE shall expect to be configured with the same number of SRS ports for all SRS resources in the SRS resource set(s) with higher layer parameter usage set as ‘antennaSwitching’. For 1T2R, 1T4R or 2T4R, or 1T6R or 1T8R, 2T6R, 2T8R, 4T8R, the UE shall not expect to be configured or triggered with more than one SRS resource set with higher layer parameter usage set as ‘antennaSwitching’ in the same slot. For 1T=1R, 2T=2R or 4T=4R, the UE shall not expect to be configured or triggered with more than one SRS resource set with higher layer parameter usage set as ‘antennaSwitching’ in the same symbol. The value of Y is defined in TABLE 1.

This indicates that, according to Release 17 of 3GPP TS 38.214, a minimum of 1 OFDM symbol blanking is specified tor all SCS within FR1, and 2 blanked OFDM symbols at SCS 120 kHz for FR2.

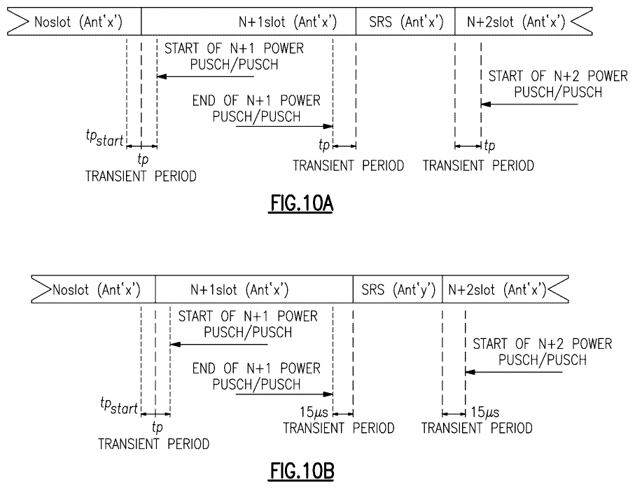

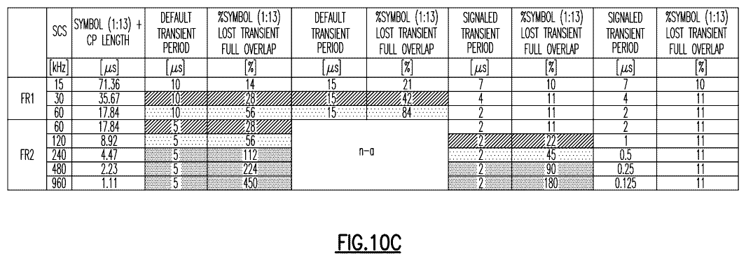

FIG. 10A is a diagram of one example of an impact of transients on an uplink physical layer. In the example of FIG. 10A, when transitioning from a PUSCH/PUCCH symbol to an SRS symbol and then back to a PUSCH/PUCCH symbol, no antenna switching occurs (antenna ‘x’ used for each transmission).

FIG. 10B is a diagram of another example of an impact of transients on an uplink physical layer. In the example of FIG. 10B, when transitioning from a PUSCH/PUCCH symbol to an SRS symbol and then back to a PUSCH/PUCCH symbol, antenna switching occurs (from antenna ‘x’ to antenna ‘y’ and then back to antenna ‘x’).

FIG. 10C is a table reflecting the impact of the SRS-AS 15 μs on the OFDM symbol duration. In the example of FIG. 6B, symbol blanking due to 15 μs may be required at SCS 30 kHz and SCS 60 kHz since the transient period represents 42% and 84% of the OFDM symbol [1:13] duration respectively.

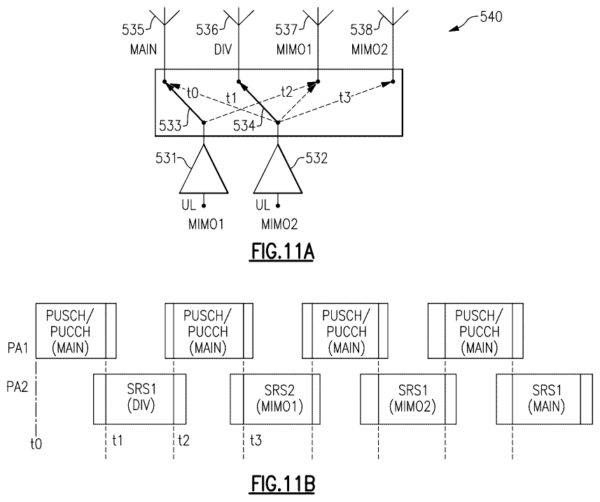

FIG. 11A is a schematic diagram of another embodiment of a communication system 540 operating with SRS for 2T4R. FIG. 11B is one example of a timing diagram for the communication system 540 of FIG. 11A.

With reference to FIGS. 11A and 11B, the communication system 540 includes a first power amplifier 531 that is connected to a main antenna 535 and a first MIMO antenna 537 by a first multi-throw switch 533. Additionally, the communication system 540 further includes a second power amplifier 532 that is connected to the main antenna 535, a diversity antenna 536, the first MIMO antenna 537, and a second MIMO antenna 538 by a second multi-throw switch 532.

In comparison to the second multi-throw switch 524 of the communication system 530 of FIG. 9A, the second multi-throw switch 534 of the communication system 540 of FIG. 11A further includes two additional throws. By including the additional throws, operability for 0 μs PUSCH/PUCCH is provided, even when the switches have a 15 μs switching time.

UEs that can deliver shorter transient periods and therefore can claim no symbol blanking have the capability of performing “hot” SRS antenna switching. The term “hot-switching” refers to the fact the RF antenna switch can be toggled while full power amplifier (PA) output power is applied to its input ports. This comes in opposition to “cold switching” where a timing programming sequence is required to either reduce the RF signal power level or to switch off the RF signal prior to performing antenna switching (hence the term “cold”), and then re-establishing the RF output power level once switching has been done.

Skipping of symbol blanking may also be enabled by “warm switching”, i.e., by toggling an RF antenna switching while an output power less than a full output power of a power amplifier is applied to the input port of the RF antenna switch, such as 50 to 90% of the full output power of a power amplifier, 60 to 80% of the full output power of a power amplifier, or 75% of the full output power of a power amplifier.

US 2020/366532 A1 discloses apparatus and methods for SRS switching. Transmit path resources of a UE are used to reduce or eliminate the impairment of SRS upon transport capacity. SRS switching time can be reduced by re-using transmit path resources that may be included for other purposes. Examples of hardware implementations are disclosed where the simultaneous switching across two power amplifiers enables near zero microsecond switching time/transient period. The implementations enabling reduced SRS switching time shown in U.S. Pat. No. 11,245,552 B2 are incorporated herein by reference in their entirety.

US 2022/407571 A1 discloses further hardware implementations that enable fast switching. The concept relies on a programming sequence which enables a form of “warm-switching” where the PA experiences the following “make-before-break” sequence: (a) reduce the power amplifier gain with connection to antenna 1 by lowering the power amplifier bias, (b) actuate the antenna switch to connect the power amplifier to antenna 2 after a given delay, (c) restore the power amplifier gain while connected to antenna 2, (d) perform a sounding reference signal symbol transmission on antenna 2. This sequence ensures no damage will be caused to the PA during the short period over which the antenna switch is neither connecting the PA to antenna 1 nor to antenna 2, therefore a short period of time over which the PA may experience high reflections due to the open circuit presented at its output port. High reflections at high power (i.e. under “hot switching”) may lead to PA destruction. The implementations enabling reduced SRS switching time shown in US 2022/407571 A1 are incorporated herein by reference in their entirety.

The timing diagram of FIG. 11B depicts SRS transient for an UL MIMO capable UE not in MIMO transmission mode.

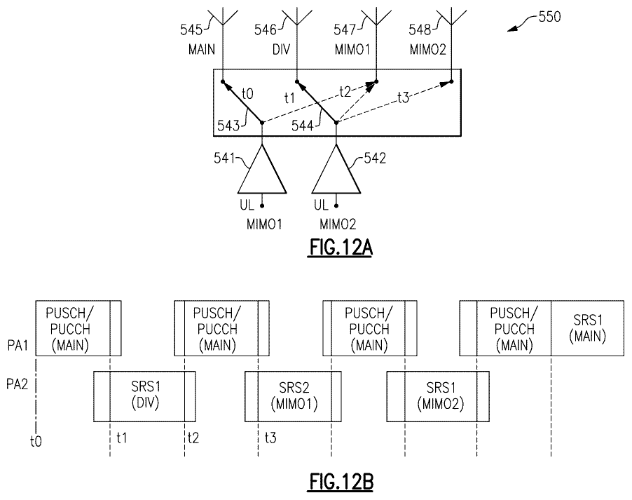

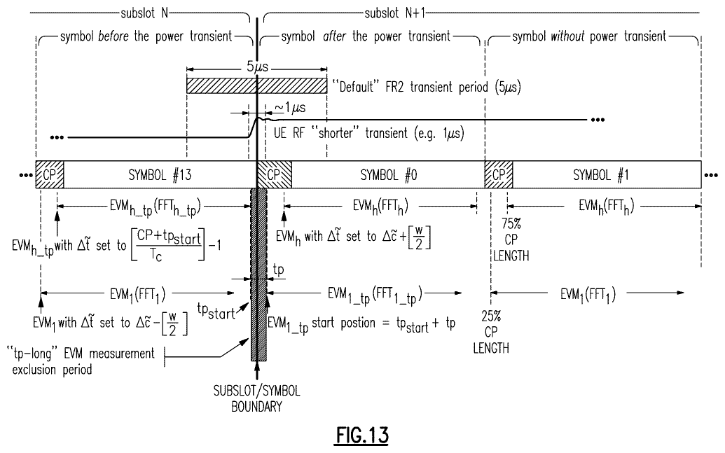

FIG. 12A is a schematic diagram of another embodiment of a communication system 550 operating with SRS for 2T4R. FIG. 12B is one example of a timing diagram for the communication system 550 of FIG. 12A.

With reference to FIGS. 12A and 12B, the communication system 550 includes a first power amplifier 541 that is connected to a main antenna 545 and a first MIMO antenna 547 by a first multi-throw switch 543. Additionally, the communication system 550 further includes a second power amplifier 542 that is connected to a diversity antenna 546, the first MIMO antenna 547, and a second MIMO antenna 548 by a second multi-throw switch 544.

The timing diagram of FIG. 12B depicts SRS transient for an UL MIMO capable UE not in MIMO transmission mode.

FIG. 13 is a schematic of an example illustrating how EVM measurements may be performed in e.g. FR1 to verify the UE reported transient period capability. As can be seen in FIG. 13, no EVM measurement is performed during the transient period.

According to Release 18 of 3GPP TS 38.101-1, the Error Vector Magnitude (EVM) is a measure of the difference between the reference waveform and the measured waveform. This difference is called the error vector. Before calculating the EVM the measured waveform is corrected by the sample timing offset and RF frequency offset. Then the carrier leakage shall be removed from the measured waveform before calculating the EVM.

The measured waveform is further equalized using the channel estimates subjected to the EVM equalizer spectrum flatness requirement specified in clause 6.4.2.4 of 3GPP TS 38.101-1. For DFT-s-OFDM waveforms, the EVM result is defined after the front-end FFT and IDFT as the square root of the ratio of the mean error vector power to the mean reference power expressed as a %. For CP-OFDM waveforms, the EVM result is defined after the front-end FFT as the square root of the ratio of the mean error vector power to the mean reference power expressed as a %.

The basic EVM measurement interval in the time domain is one preamble sequence for the PRACH and one slot for PUCCH and PUSCH in the time domain. The EVM measurement interval is reduced by any symbols that contains an allowable power transient in the measurement interval, as defined in clause 6.3.3 3GPP TS 38.101-1.

The RMS average of the basic EVM measurements over 10 subframes for the case of average EVM without power transients, and over 60 subframes for the reference signal EVM case, for the different modulation schemes shall not exceed the values specified in Table 6.4.2.1-1 of 3GPP TS 38.101-1 for the parameters defined in Table 6.4.2.1-2 of 3GPP TS 38.101-1. For EVM evaluation purposes, all 13 PRACH preamble formats and all 5 PUCCH formats are considered to have the same EVM requirement as QPSK modulated.

A new UE capability signaling is proposed.

A UE send a message to a gNb to report that it is capable of supporting continuous symbol scheduling, i.e., the UE is capable of skipping symbol blanking, no matter what SCS (15, 30, 60 kHz for FR1 or 60, 120 kHz for FR2) or what frequency range of operation is in use (FR1 or FR2). The reporting may be optional and may be declared/supported per band of operation.

Upon reception of this message, the gNb scheduler knows that the UE solves symbol blanking limitation. The gNb scheduler can therefore allocate continuous uplink symbols.

Said capability signaling could be encoded over 1 bit to signal that the UE either supports or does not support symbol blanking skip. Said capability signaling could also be encoded over 2 bits depending on agreements for test methodologies. 2 bits might be needed in case where certain UEs might support skipping symbol blanking but would slightly degrade EVM, for example in the case of using high order modulation schemes such as 256 QAM. In this case, UEs may be distinguished for which a slight EVM relaxation is to be expected when severe repetitive power steps occur at high SCS, high modulation orders and consecutive symbol scheduling for low latency applications. The performance of such an UE may be quantified by assessing its EVM performance when consecutive symbols are scheduled in problematic cases, such as the cases illustrated in FIG. 6D and FIG. 6A in FR1 at SCS 60 kHz and in FR2 at SCS 120 kHz, and in the cases as described above in relation to Release 17 of 3GPP TS 38.214.

Operation in FR1 and FR2 at lower SCS is not affected because transients are short as compared the duration of the cyclic prefix (CP) of the respective OFDM symbol. EVM measurement period for impact of RF transients applies only to cases where a power change occurs. The FFT window length may remain as currently defined, but EVM measurements/calculation should not include FFT samples that may be “located” during the RF transient period.

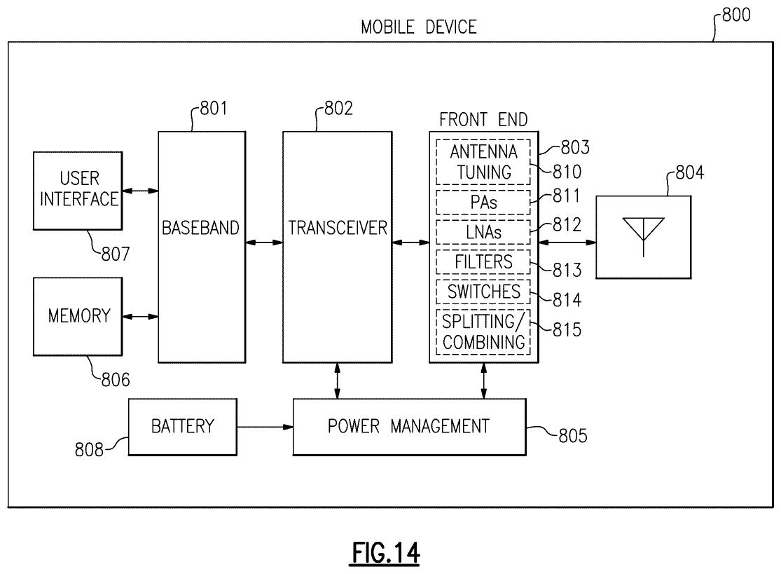

FIG. 14 is a schematic diagram of one embodiment of a mobile device 800. The mobile device 800 includes a baseband system 801, a transceiver 802, a front end system 803, antennas 804, a power management system 805, a memory 806, a user interface 807, and a battery 808. The mobile device 800 can be implemented in accordance with any of the embodiments herein, including any of the embodiments shown and described with respect to FIGS. 6A-13, or any other disclosed embodiments.

The mobile device 800 can be used communicate using a wide variety of communications technologies, including, but not limited to, 2G, 3G, 4G (including LTE, LTE-Advanced, and LTE-Advanced Pro), 5G NR, WLAN (for instance, WiFi), WPAN (for instance, Bluetooth and ZigBee), WMAN (for instance, WiMax), and/or GPS technologies.

The transceiver 802 generates RF signals for transmission and processes incoming RF signals received from the antennas 804. It will be understood that various functionalities associated with the transmission and receiving of RF signals can be achieved by one or more components that are collectively represented in FIG. 14 as the transceiver 802. In one example, separate components (for instance, separate circuits or dies) can be provided for handling certain types of RF signals.

The front end system 803 aids in conditioning signals transmitted to and/or received from the antennas 804. In the illustrated embodiment, the front end system 803 includes antenna tuning circuitry 810, power amplifiers (PAs) 811, low noise amplifiers (LNAs) 812, filters 813, switches 814, and signal splitting/combining circuitry 815. However, other implementations are possible.

For example, the front end system 803 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 800 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 804 can include antennas used for a wide variety of types of communications. For example, the antennas 804 can include antennas for transmitting and/or receiving signals associated with a wide variety of frequencies and communications standards.

In certain implementations, the antennas 804 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 800 can operate with beamforming in certain implementations. For example, the front end system 803 can include amplifiers having controllable gain and phase shifters having controllable phase to provide beam formation and directivity for transmission and/or reception of signals using the antennas 804. For example, in the context of signal transmission, the amplitude and phases of the transmit signals provided to the antennas 804 are controlled such that radiated signals from the antennas 804 combine using constructive and destructive interference to generate an aggregate transmit signal exhibiting beam-like qualities with more signal strength propagating in a given direction. In the context of signal reception, the amplitude and phases are controlled such that more signal energy is received when the signal is arriving to the antennas 804 from a particular direction. In certain implementations, the antennas 804 include one or more arrays of antenna elements to enhance beamforming.

The baseband system 801 is coupled to the user interface 807 to facilitate processing of various user input and output (I/O), such as voice and data. The baseband system 801 provides the transceiver 802 with digital representations of transmit signals, which the transceiver 802 processes to generate RF signals for transmission. The baseband system 801 also processes digital representations of received signals provided by the transceiver 802. As shown in FIG. 14, the baseband system 801 is coupled to the memory 806 of facilitate operation of the mobile device 800.

The memory 806 can be used for a wide variety of purposes, such as storing data and/or instructions to facilitate the operation of the mobile device 800 and/or to provide storage of user information.

The power management system 805 provides a number of power management functions of the mobile device 800. In certain implementations, the power management system 805 includes a PA supply control circuit that controls the supply voltages of the power amplifiers 811. For example, the power management system 805 can be configured to change the supply voltage(s) provided to one or more of the power amplifiers 811 to improve efficiency, such as power added efficiency (PAE).

As shown in FIG. 14, the power management system 805 receives a battery voltage from the battery 808. The battery 808 can be any suitable battery for use in the mobile device 800, including, for example, a lithium-ion battery.

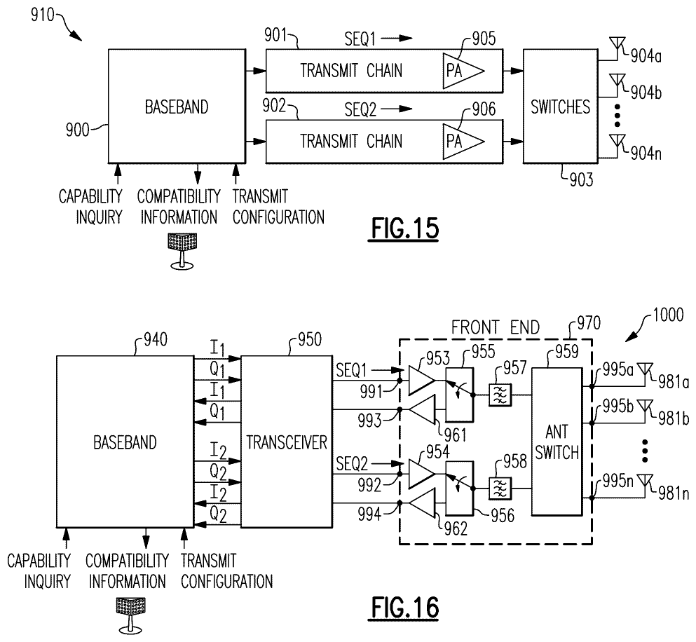

FIG. 15 is a schematic diagram of one embodiment of an RF communication system 910. The RF communication system 910 includes a baseband system 900, a first transmit chain 901, a second transmit chain 902, switches 903, and antennas 904a, 904b, . . . 904n. The RF communication system 910 represents a wireless device of a cellular network, such as a mobile phone. The RF communication system 910 can be implemented in accordance with any of the embodiments herein, including any of the embodiments shown and described with respect to FIGS. 6A-13, or any other disclosed embodiments. For example, the RF communication system 910 can implement portions of the mobile device 800 of FIG. 14, such as where the baseband 900 corresponds to the baseband processor 801, the transmit chains 901, 902 correspond to portions of the transceiver 802 and/or front end 803, and the switches 903 correspond to one or more of the switches 814 of the front end 803.

As shown in FIG. 15, the baseband system 900 generates a first transmit signal and a second transmit signal, which in certain implementations are represented each using a pair of in-phase (I) and quadrature-phase (Q) signals.

With continuing reference to FIG. 15, the first transmit chain 901 includes a first power amplifier 905, and the second transmit chain 902 includes a second power amplifier 906. The first power amplifier 905 is used to amplify a first RF transmit signal carrying a first sequence of symbols (SEQ1). Additionally, the second power amplifier 906 is used to amplify a second RF transmit signal carrying a second sequence of symbols (SEQ2).

As shown in FIG. 15, the switches 903 are used to selectively connect the first power amplifier 905 and the second power amplifier 906 to desired antenna(s) chosen from the antennas 904a, 904b, . . . 904n. Although the RF communication system 910 is depicted as included three antennas, more or fewer antennas can be included as indicated by the ellipses.

The baseband system 900 controls generation of the first RF transmit signal and the second RF transmit signal such that the first sequence of symbols and the second sequence of symbols are staggered with one or more sounding reference signal symbols in the second sequence of symbols in accordance with the teachings herein.

As shown in FIG. 15, the baseband system 900 is further configured to receive a base station capability inquiry from a base station, and to control transmission of capability information to the base station in response to the base station capability inquiry. In certain implementations, the baseband system 900 can further receive transmit configuration information from the base station in response to sending the compatibility information. The baseband system 900 can configure first transmit chain 901, second transmit chain 902, and/or the switches 903 based on the inquiry and/or transmit configuration information.

FIG. 16 is a schematic diagram of another embodiment of an RF communication system 1000. The RF communication system 1000 includes a baseband system 940, a transceiver 950, a front end system 970, and antennas 981a, 981b, . . . 981n. The RF communication system 1000 represents a wireless device of a cellular network, such as a mobile phone. The RF communication system 1000 can be implemented in accordance with any of the embodiments herein, including any of the embodiments shown and described with respect to FIGS. 6A-13, or any other disclosed embodiments. For example, the RF communication system 1000 can implement portions of the mobile device 800 of FIG. 14, such as where the baseband 940 corresponds to the baseband processor 801, the transceiver 950 correspond to the transceiver 802, and the front end 970 can correspond to the front end 803.

As shown in FIG. 16, the baseband system 940 generates a first pair of in-phase (I) and quadrature-phase (Q) signals representing a first transmit signal. Additionally, the baseband system 940 processes a first pair of I and Q signals representing a first receive signal. Furthermore, the baseband system 940 generates a second pair of I and Q signals representing a second transmit signal. Additionally, the baseband system 940 processes a second pair of I and Q signals representing a second receive signal.

With continuing reference to FIG. 16 the transceiver 950 modulates the first pair of I and Q signals representing the first transmit signal to generate a first RF transmit signal provided to the front end system 970 at a first transmit terminal 991. The first RF transmit signal carries a first sequence of symbols (SEQ1). Additionally, the transceiver 950 demodulates a first RF receive signal from a first receive terminal 993 of the front end system 970 to generate the first pair of I and Q signals representing the first receive signal. Furthermore, the transceiver 950 modulates the second pair of I and Q signals representing the second transmit signal to generate a second RF transmit signal provided to the front end system 970 at a second transmit terminal 992. The second RF transmit signal carriers a second sequence of symbols (SEQ2). Additionally, the transceiver 970 demodulates a second RF receive signal from a second receive terminal 994 of the front end system 970 to generate the second pair of I and Q signals representing the second receive signal.

As shown in FIG. 16, the front end system 970 includes a first power amplifier 953, a second power amplifier 954, a first transmit/receive switch 955, a second transmit/receive switch 956, a first band filter 957, a second band filter 958, an antenna switch 959, a first low noise amplifier 961, and a second low noise amplifier 962.

Although one embodiment of a front end system 970 is shown, other implementations of front end systems are possible. For example, a wide range of components and circuitry can be present between an output of a power amplifier and an antenna. Examples of such components and circuitry include, but are not limited to, switches, matching networks, harmonic termination circuits, filters, resonators, duplexers, detectors, directional couplers, bias circuitry, and/or frequency multiplexers (for instance, diplexers, triplexers, etc.). Furthermore, multiple instantiations of one or more components or circuits can be included. Moreover, a wide range of components and circuitry can be present between the transceiver and an input to a power amplifier.

As shown in FIG. 16, the antenna switch 959 is used to selectively connect the first power amplifier 953 and the second power amplifier 954 to desired antenna(s) chosen from the antennas 981a, 981b, . . . 981n. The front end system 970 is coupled to the antennas 981a, 981b, . . . 981n at antenna terminals 995a, 995b, . . . 995n, respectively. Although the RF communication system 1000 is depicted as included three antennas, more or fewer antennas can be included as indicated by the ellipses.

In the illustrated embodiment, the RF communication system 1000 includes a first transmit path through the first power amplifier 953 and a second transmit path through the second power amplifier 954. The first transmit path is for the first RF transmit signal carrying the first sequence of symbols (SEQ1) and the second transmit path is for the second RF transmit signal carrying the second sequence of symbols (SEQ2).

The baseband system 940 controls generation of the first RF transmit signal and the second RF transmit signal such that the first sequence of symbols and the second sequence of symbols are staggered with one or more sounding reference signal symbols in the second sequence of symbols.

As shown in FIG. 16, the baseband system 940 is further configured to receive a base station capability inquiry from a base station, and to control transmission of capability information to the base station in response to the base station capability inquiry. In certain implementations, the baseband system 940 can further receive transmit configuration information from the base station. The baseband system 940 can configure the transceiver 950 and/or the front end system 970 based on the inquiry and/or transmit configuration information.

Aspects of this disclosure can be implemented in various electronic devices. Examples of the electronic devices can include, but are not limited to, consumer electronic products, parts of the consumer electronic products such as packaged radio frequency modules, radio frequency filter die, uplink wireless communication devices, wireless communication infrastructure, electronic test equipment, etc. Examples of the electronic devices can include, but are not limited to, a mobile phone such as a smart phone, a wearable computing device such as a smart watch or an ear piece or smart eyeglasses or virtual reality equipment, a telephone, a television, a computer monitor, a computer, a modem, a hand-held computer, a laptop computer, a tablet computer, a microwave, a refrigerator, a vehicular electronics system such as an automotive electronics system, a robot such as an industrial robot, an Internet of things device, a stereo system, a digital music player, a radio, IoT radios, a camera such as a digital camera, a portable memory chip, a home appliance such as a washer or a dryer, a peripheral device, a wrist watch, a clock, etc. Further, the electronic devices can include unfinished products.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to.” Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly coupled, or coupled by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

While certain embodiments have been described, these embodiments have been presented by way of example only, and are not intended to limit the scope of the disclosure. Indeed, the novel resonators, filters, multiplexer, devices, modules, wireless communication devices, apparatus, methods, and systems described herein may be embodied in a variety of other forms. Furthermore, various omissions, substitutions and changes in the form of the resonators, filters, multiplexer, devices, modules, wireless communication devices, apparatus, methods, and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and/or acts of the various embodiments described above can be combined to provide further embodiments. The accompanying claims and their equivalents are intended to cover such forms or modifications as would fall within the scope and spirit of the disclosure.

What is claimed is:

1. A mobile device having a capability of skipping symbol blanking, the mobile device comprising:
a transceiver;
a radio frequency front end system coupled to the transceiver; and
a baseband system configured to generate a sequence of symbols for transmission to a base station by way of the radio frequency front end system coupled to the transceiver, and to generate a sequence of symbols including capability information, the capability information indicating that the mobile device has the capability of skipping symbol blanking.

2. The mobile device of claim 1, wherein the radio frequency front end system includes an RF antenna switch having an input port, the RF antenna switch configured to be toggled while an output power of a power amplifier is applied to the input port.

3. The mobile device of claim 1 wherein the capability of skipping symbol blanking is encoded over 1 bit per supported frequency band of operation either within frequency range 1 (FR1) or within frequency range 2 (FR2).

4. The mobile device of claim 3 wherein an error vector magnitude (EVM) measurement period spans from and end of a transition period.

5. The mobile device of claim 1 wherein the baseband system is further configured to receive a base station capability inquiry, and to control transmission of the capability information in response to the base station capability inquiry.

6. The mobile device of claim 1 wherein the capability of skipping symbol blanking is encoded over 2 or more bits.

7. The mobile device of claim 1 wherein the mobile device has the capability of skipping symbol blanking in at least one of frequency range 1 (FR1) and frequency range 2 (FR2).

8. A method of indicating, by a mobile device including a transceiver, a radio frequency front end system coupled to the transceiver, and a baseband system, that the mobile device has a capability of skipping symbol blanking, the method comprising:
generating a sequence of symbols for transmission to a base station by way of the radio frequency front end system coupled to the transceiver; and
generating a sequence of symbols including capability information, the capability information indicating that the mobile device has the capability of skipping symbol blanking.

9. The method of claim 8 wherein the radio frequency front end system includes an RF antenna switch having an input port, the RF antenna switch configured to be toggled while an output power of a power amplifier is applied to the input port.

10. The method of claim 8 further comprising encoding the capability of skipping symbol blanking over 1 bit per supported frequency band of operation either within frequency range 1 (FR1) or within frequency range 2 (FR2).

11. The method of claim 9 further comprising measuring an error vector magnitude (EVM) over a period that spans from and end of a transition period.

12. The method of claim 8 further comprising receiving a base station capability inquiry and controlling transmission of the capability information in response to the base station capability inquiry.

13. The method of claim 8 further comprising encoding the capability of skipping symbol blanking over 2 or more bits.

14. The method of claim 8 further comprising skipping symbol blanking in at least one of frequency range 1 (FR1) and frequency range 2 (FR2).

15. A communication system having a capability of skipping symbol blanking, the communication system comprising:
a transceiver;
a radio frequency front end system coupled to the transceiver; and
a baseband system configured to generate a sequence of symbols for transmission to a base station by way of the radio frequency front end system coupled to the transceiver, and to generate a sequence of symbols including capability information, the capability information indicating that the communication system has the capability of skipping symbol blanking.

16. The communication system of claim 15 wherein the radio frequency front end system includes an RF antenna switch having an input port, the RF antenna switch configured to be toggled while an output power of a power amplifier is applied to the input port.

17. The communication system of claim 15 wherein the capability of skipping symbol blanking is encoded over 1 bit per supported frequency band of operation either within frequency range 1 (FR1) or within frequency range 2 (FR2).

18. The communication system of claim 15 wherein an error vector magnitude (EVM) measurement period spans from and end of a transition period.

19. The communication system of claim 15 wherein the capability of skipping symbol blanking is encoded over 2 or more bits.

20. The communication system of claim 15 wherein the communication system has the capability of skipping symbol blanking in at least one of frequency range 1 (FR1) and frequency range 2 (FR2).
